(19) United States
(12) Patent Application Publication
(10) Pub. No.: US 2011/0082047 A1
(43) Pub. Date: Apr. 7, 2011

(54) GENOME-WIDE SCREENING FOR SNPs AND MUTATIONS RELATED TO DISEASE CONDITIONS

(76) Inventors: Jörg Hoheisel, Heidelberg (DE); Philipp Angenendt, Baltimore, MD (US)

(21) Appl. No.: 12/309,765

(22) PCT Filed: Jul. 30, 2007
(86) PCT No.: PCT/US2007/074742

§ 371 Date: Jun. 22, 2009

Related U.S. Application Data
(60) Provisional application No. 60/834,170, filed on Jul. 31, 2006.

(51) Int. Cl. C40B 30/04; C40B 30/00

(52) U.S. Cl. 506/9; 506/7

(57) ABSTRACT

The present invention provides a genome-wide methodology for identifying single nucleotide polymorphisms and mutations related to disease conditions, such as cancer. Specifically, the invention provides methods for detecting genome-wide mutations by successively amplifying sequence differences between two sample populations.

This International application claims priority to U.S. Provisional Application Ser. No. 60/834,170, which was filed on Jul. 31, 2006, and which is incorporated herein by reference.

### FIELD OF THE INVENTION

The present invention relates to methods for genome-wide detection of single nucleotide polymorphisms or mutations related to disease conditions, such as but not limited to cancer. Specifically, the invention provides methods for detecting genome-wide mutations by successively amplifying sequence differences between two sample populations. The invention also provides methods for diagnosing, treating, or preventing disorders associated with such genome-wide mutations.

### INTRODUCTION

Cancer is a genetic disease arising from a successive collection of abnormalities in the DNA sequence of the genome. Such abnormalities, or mutations, can alter the function of a gene, leading to an amino acid exchange or truncation of a resulting protein, which in turn provides a growth advantage to the cell. The identification of such mutations that drive oncogenesis is a central focus of modern cancer research, with profound implications for diagnosis and therapeutic intervention.

Currently, high-throughput sequencing of cancerous and non-cancerous cells are used for investigating and comparing sequence variations between cancerous and non-cancerous cells. See Wang et al., Science 304, 1164-6 (2004); Samuels et al., Science 304, 554 (2004); and Parsons et al., Nature 436, 792 (2005). However, due to technical complexities and financial concerns, sequencing is not performed on a whole-genome scale, but rather sequencing is limited to a pre-selected group of genes, such as all genes encoding kinases. Because only specific genes are selected for analysis, the vast majority of genes in a genome cannot be analyzed using high-throughput sequencing. Additionally, non-coding sequences, which carry important regulatory elements and are primary targets for mutations promoting cell growth, are also not analyzed.

Other methods are typically employed for detecting mutations. For example, mutations can be identified by forming heteroduplexes and analyzing their mobility profiles on non-denaturing polyacrylamide gels (See Keen et al., Trends Genet 7, 5 (1991)), as well as recording abnormal denaturation profiles using denaturing high performance liquid chromatography (dHPLC) ((Kosaki et al., Mol Genet Metab 86, 117-23 (2005)) or denaturing gradient gel electrophoresis (DGGE). Cariello et al., Am J Hum Genet 42, 726-34 (1988). Alternatively, heteroduplexes can be cleaved by chemical means or endonucleases, such as T4 phage resolvase (Mashal et al., Nat Genet 9, 177-83 (1995)). or CELI nuclease (Oleykowski, C. A., Nucleic Acids Res 26, 4597-602 (1998); Yang et al., Biochemistry 39, 3533-41 (2000)), and detecting the cleaved products on gels. A third approach, called single-strand conformation analysis, relies on the formation of conformation polymorphisms upon snap-cooling of single stranded DNA and subsequently analyzing mobility profiles on nondenaturing polyacrylamide gels. Orita et al., Proc Natl Acad Sci USA 86, 2766-70 (1989). Finally, protein truncation tests are applied, which are based on the transcription and translation of RT-PCR products, and detect frameshifts, splice site, or nonsense mutations that create a premature termination codon by truncated protein products. Roest et al., Hum Mol Genet 2, 1719-21 (1993).

While all of these techniques are presently used for detecting mutations, each method has limited capability for identifying de novo mutations, since each technique is based on an electrophoretic or chromatographic separation step. This restricts their use to the analysis of single or few genes at a time, which can be separated from each other and limits their use for a comparative genomic analysis of highly diverged samples, such as a human genome, where a large number of polymorphic sites are present. Sokurenko et al., Nucleic Acids Res 29, E111 (2001). However, since knowledge about all mutations that are crucial in the development of cancer are key to an optimal cancer diagnosis and treatment, there is a need for a cost-effective methodology that allows the genome-wide identification of cancer-specific mutations against the background of a vast excess of non-cancer related polymorphisms. Accordingly, the present invention provides methods for detecting single nucleotide polymorphisms or mutations, related to cancer, on a genome-wide scale.

### SUMMARY OF THE INVENTION

One aspect of the present invention is a method for identifying a genome-wide mutation, comprising:

(a) providing nucleic acids from two sample pools of a subject, wherein a first sample pool is obtained from an diseased cell and a second sample pool is obtained from a normal cell;

(b) digesting each nucleic acids in each sample pool to generate at least two fragments;

(c) ligating a short oligonucleotide adapter to each fragment at a site of mismatch cleavage; and

(d) selectively amplifying and identifying the sequence differences between the two sample pools to identify a mutation.

In one embodiment of any of the methods disclosed herein, the nucleic acids are DNA or RNA. In one embodiment, the nucleic acids are DNA. In another embodiment, the nucleic acids are RNA. If RNA is provided from each sample, then those RNA molecules can be reverse transcribed according to standard techniques to produce cDNAs which can then be manipulated according to the present inventive methodology to identify any mutations in its sequence.

In one embodiment, the two samples are either normal, e.g., “healthy,” or abnormal, i.e., “unhealthy,” samples which are taken from a subject, i.e., an individual. The individual may have cancer, Huntington's disease, adult polycystic kidney disease, Alzheimer's disease, Down's syndrome, autoimmune diseases, cardiovascular diseases, infectious diseases such as AIDS, hepatitis, or other pathological conditions of known and unknown origins. In another embodiment, the disease is a genetic disease, i.e., one that is characterized as a problem stemming from a genetic mutation, gene or chromosomal problem, or is a genetic hereditary disease.

Common genetic disorders include, but are not limited to, 22q11.2 deletion syndrome, Angelman syndrome, Canavan disease, Celiac disease, Charcot-Marie-Tooth disease, Color blindness, Cri du Chat, Cystic fibrosis, Down syndrome, Duchenne muscular dystrophy, Hemophilia, Klinefelter syndrome, Neurofibromatosis, Phenylketonuria, Prader-Willi syndrome, Sickle-cell disease, Spina bifida, Tay-Sachs disease, and Turner syndrome.

In one embodiment, the diseased cell is a cancer cell. The cancer includes, but is not limited to, cancers of tissues; cancers of blood or hematopoietic origin; as well as anal cancer, bladder cancer, bone cancer, brain tumors, breast cancer, cervical cancer, chemotherapy-related Hair Loss, chronic myelogenous leukemia, colon cancer, esophageal cancer, gastrointestinal cancers, gynecologic cancers, Hodgkin's Disease, kidney cancer, laryngeal cancer, leukemia, liver cancer, lung cancer, lymphoma, mesothelioma, myeloma, neuroblastoma, oral cancer, ovarian cancer, pancreatic cancer, prostate cancer, retinoblastoma, rhabdomyosarcoma, skin cancer, stomach (Gastric) cancer, testicular cancer, thyroid cancer, uterine cancer, or Waldenstrom's Macroglobulinemia. In another embodiment, the individual has a cancer that is categorized as one that has little, if any, microsatellite instability. See Rajagopalan H, Nowak M A, Vogelstein B, Lengauer C. The significance of unstable chromosomes in colorectal cancer. Nat Rev Cancer. 2003 September; 3(9):695-701.

The healthy sample may be a sample of tissue or blood or other biological material which is not diseased. Accordingly, a “healthy” sample is one that is taken from a site in the individual that is not near or located around a site known to be diseased or not healthy. Thus, a first sample can be taken from an area of an organ which is free from disease in an area distinct from a diseased region of the same organ. Or a healthy sample can be taken from a distinct part of the individual's body that is removed from the site or area of the diseased biological material.

In one embodiment, the individual is a mammal. In one embodiment, the individual is a human, dog, cat, cattle, pig, sheep, rat, mouse, guinea pig, hamster, horse, cow, chicken, rodent. In another embodiment, the individual is a human. In one embodiment, the human is a man, woman, child, unborn child, fetus, or embryo. The present invention is not limited to testing for genomic mutations from mammals. Other species can be examined in the same way for genomic mutations, such as plants, fungi, reptiles, birds, fish, insects, bacteria, and viruses. The genomic or nucleic acid components of these other non-mammalian species also can be examined according to the inventive methods disclosed herein.

In another embodiment, the step of selectively amplifying and identifying the sequence differences is performed by a method selected from the group consisting of differential display, representational differential analysis, suppressive subtraction hybridization, serial analysis of gene expression, gene expression microarray, nucleic acid chip technology, and direct sequencing.

In another embodiment, the fragments that are generated according to the present invention are protected against exonuclease activity, such as against the exonuclease activity of Cell. Protection of this sort can be accomplished by modifying the ends of the fragments by attaching the biotin and streptavidin moieties, which is a standard and well-known laboratory procedure.

Another aspect of the present invention is a method for identifying a oncogenic mutation comprising:

(a) providing DNA from two sample pools of a subject, wherein a first sample pool is obtained from a cancer cell and a second sample pool is obtained from a normal cell;

(b) digesting each DNA sample pool to generate DNA fragments;

(c) ligating a short oligonucleotide adapter to each fragment at a site of mismatch cleavage; and

(d) selectively amplifying and identifying the sequence differences between the two sample pools to identify an oncogenic mutation.

Another aspect of the present invention is a method for identifying a genome-wide mutation, comprising:

(a) providing DNA from two sample pools of a subject, wherein a first sample pool is obtained from an diseased cell and a second sample pool is obtained from a normal cell;

(b) digesting each DNA sample pool to generate at least two DNA fragments;

(c) ligating a short oligonucleotide adapter carrying a recognition site for a type IIS restriction endonuclease to each fragment at a site of mismatch cleavage

(d) digesting all fragments with a type IIS restriction endonuclease and ligating a second short oligonucleotide adapter to the site of IIS restriction endonuclease cleavage; and

(e) selectively amplifying and identifying the sequence differences between the two sample pools to identify a mutation.

In one embodiment, the DNA is genomic DNA. In another embodiment, the genomic DNA is pre-treated with sodium bisulfite. See U.S. Pat. No. 6,017,704, which is incorporated herein by reference.

Another aspect of the present invention is a method for identifying a genome-wide mutation, comprising:

(a) providing nucleic acids from two DNA samples, wherein a first DNA sample is obtained from a cell from an individual with a disease and the second DNA sample is obtained from a normal cell;

(b) digesting each nucleic acids in each sample pool to generate at least two fragments;

(c) ligating a short oligonucleotide adapter to each fragment at a site of mismatch cleavage; and

(d) selectively amplifying and identifying the sequence differences between the two sample pools to identify a mutation.

In this particular method, the second (“normal”) DNA sample does not necessarily have to be isolated from the diseased individual, but may be taken from a completely healthy individual of the same species, or from an individual of the same species who does not have the disease of the diseased individual. If the individual to be tested is a human, then the second DNA sample may come from an individual of the same race or from a biological family member related to the individual. The race of the human may be Capoid or Khoisanid Subspecies of southern Africa, Congoid Subspecies of sub-Saharan Africa, Central African race, Bambutid race (African Pygmies), Aethiopid race (Ethiopia, Somalia; hybridized with Caucasoids), Mediterranid race, Dinaric race, Alpine race, Ladogan race, Nordish or Northern European race, Armenid race, Turanid race, Irano-Afghan race, Indic or Nordindid race, Dravidic race (India, Bangladesh and Sri Lanka [Ceylon]; ancient stabilized Indic-Veddoid blend), Veddoid race, Negritos, Melanesian race, Australian-Tasmanian race (Australian Aborigines), Mongoloid Subspecies, such as Northeast Asian race (various subraces in China, Manchuria, Korea and Japan) and Southeast Asian race (various subraces in Indochina, Thailand, Malaysia, Indonesia and the Philippines, some partly hybridized with Australoids), and Amerindian race (American Indians; various subraces).

Hence, the DNA from the individual who is to be tested for genomic single nucleotide polymorphisms can be compared against, or made to form duplexes with, DNA fragments produced from an entirely different individual, or DNA that is pooled in the form of an artificial library of DNAs. The library of DNAs may include normal copies of fragments of gene sequences that are known to be implicated in certain genetic diseases.

Accordingly, the present invention encompasses identifying genomic mutations from an individual's sample by and reannealing fragmented DNA strands obtained from DNAs from healthy and unhealthy, normal and abnormal cells taken from the same individual. But the present invention also encompasses identifying genomic mutations from an individual's sample by and reannealing fragmented DNA strands obtained from DNAs an unhealthy or abnormal cell sample taken from a diseased individual and those obtained from DNAs from a different individual of the same species or those obtained from a discreet DNA library. Accordingly, the present invention can also be applied to determining the presence of genetic mutations between one and another individual, groups of individuals, or between subpopulations of individuals.

Both the foregoing summary and the following brief description of the drawings and the detailed description are exemplary and explanatory and are intended to provide further explanation of the invention as claimed. Other objects, advantages, and novel features will be readily apparent to those skilled in the art from the following detailed description of the invention.

### BRIEF DESCRIPTION OF THE DRAWINGS

FIG. 1. Displays the reaction products from PCR detection. Lane 3 shows the PCR products generated using Primer 1 and Primer 3. While Primer 1 binds to a sequence on the original DNA fragment, Primer 3 is specific for a sequence on the adapter, which was ligated to the fragments. Therefore, a ligation of the adapter to the site of the mismatch cleavage would lead to a DNA fragment of the size of 263 (217 bp+48 bp adapter), which is indicated by the arrow. The two additional bands of lane 3 arise from the ligation of the adapter to the ends of the uncut DNA fragment, which produce additional bands with one of them in the range of 463 bp (415 bp+48 bp adapter) to 511 bp (415 bp+48 bp adapter+48 bp adapter) and the other in the range of 680 bp (632 bp+48 bp) to 728 bp (632 bp+2*48 bp). Lane 5 shows the reactions products of the PCR with primer 1 and 2, which yields a reamplification of the original product at 632 bp.

FIG. 2. Schematic illustrating endonuclease-based digestion of two sample populations, followed by adapter ligation and type IIs restriction enzyme treatment in preparation for SAGE analysis.

FIG. 3. Schematic illustrating Subtractive Suppressive Hybridization (SSH), which leads to a successive amplification of sequence differences between two sample populations.

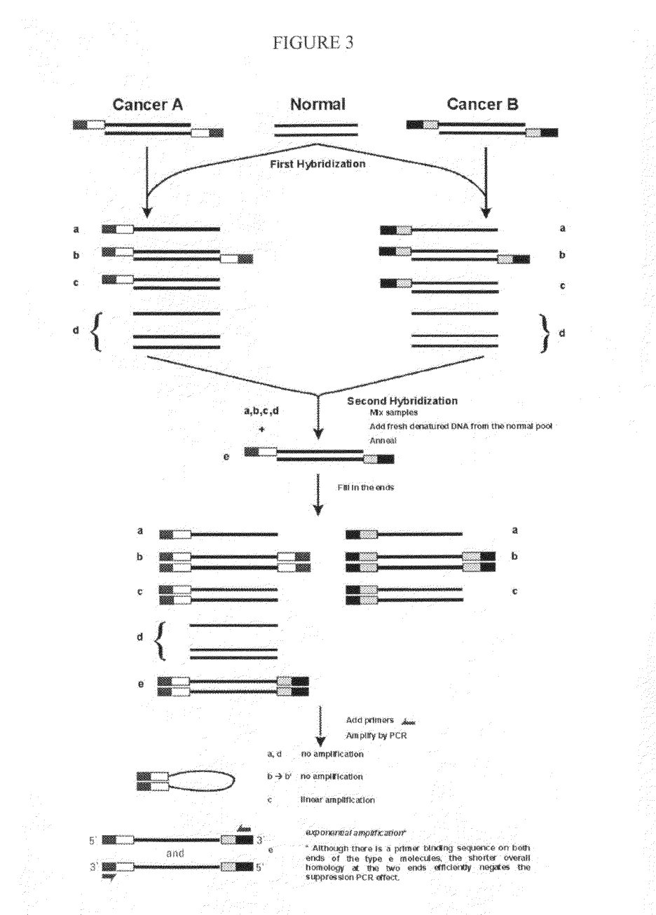

FIG. 4. PCR gel depicting results of CELI assay (Example 6). Key:LD: Low Molecular Weight Ladder: 25 bp−766 bp; Lane A: Detection of full length heteroduplex (632 bp) with primer used for initial amplification; Lane B: Detection of the longer fragment (415 bp+44 bp adapter) of digested heteroduplex with forward primer used for initial amplification (Control Primer FWD) and one adapter specific primer (P Cell Ia REV); Lane C: Detection of the shorter fragment (217 bp+44 bp adapter) of digested heteroduplex with reverse primer used for initial amplification (Control Primer REV) and one adapter specific primer (P Cell Ia REV); Lane D: Control PCR on heteroduplex using just the adapter specific primer (P Cell Ia REV); Lane E: Detection of full length homoduplex (632 bp) with primer used for initial amplification; Lane F: Missing detection of the longer fragment (415 bp) of digested homoduplex with forward primer used for initial amplification (Control Primer FWD) and one adapter specific primer (P CelI Ia REV); Lane G: Missing detection of the shorter fragment (217 bp+44 bp adapter) of digested homoduplex with reverse primer used for initial amplification (Control Primer REV) and one adapter specific primer (P Cell Ia REV); Lane H: Control PCR on homoduplex using just the adapter specific primer (P Cell Ia REV).

### DETAILED DESCRIPTION OF THE PREFERRED EMBODIMENTS

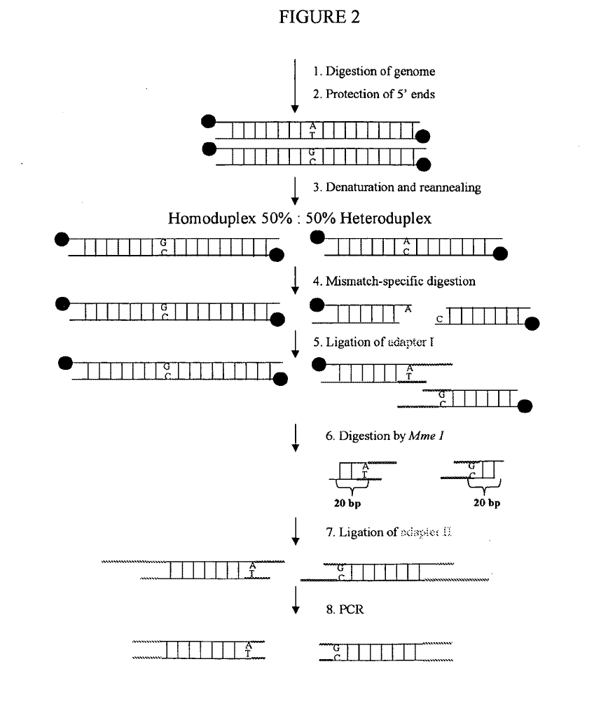

The present invention provides a genome-wide methodology for identifying single nucleotide polymorphisms and mutations, potentially related to cancer. Specifically, the invention provides methods for detecting genome-wide mutations by successively amplifying sequence differences between two sample populations. That is, the invention provides methods for discovering mutations that are preferentially or uniquely present in a diseased cell relative to a normal cell from the same subject. One elegant approach of the present method, as represented in FIG. 2, is to enzymatically digest, or otherwise fragment, two samples of an individual's genomic DNA—one that is considered to be a healthy, or non-diseased, biological sample from an individual, and another that an unhealthy sample taken from the same individual, such as from an unhealthy or diseased tissue or area or bloodstream. The strands of each of the resultant double-stranded DNA fragments from both samples are separated from one another by denaturation to create a pool of single stranded DNA fragments.

Under appropriate conditions, each of those single stranded DNAs can hybridize and reanneal to other single stranded fragments. Any strand can reanneal with any other essentially complementary strand to produce homoduplex or heteroduplex molecules. In the former, the annealing single stranded DNA fragments are exactly complementary in sequence to one another with no nucleotide mismatches. In the latter, however, the heteroduplex is a DNA molecule that shares sufficient complementary sequence identity to facilitate reannealing, but which contains one or more nucleotide mismatches. That is, in the heteroduplex the annealing fragmented strands are not 100% identical in sequence to one another over the hybridized region. That mismatch in the heteroduplex therefore represents a mutation in nucleotide sequence between a genomic fragment of the healthy sample and the corresponding fragment generated from the unhealthy genomic sample.

Under the inventive method, a restriction enzyme that recognizes mismatched duplex sequences is then applied to the reannealed duplexes and selectively cuts those heteroduplexes at the mismatch site. The enzyme does not cleave the homoduplex molecules.

A key to the present invention is the subsequent ligation of an adapter oligonucleotide to each cleaved end of the heteroduplex pair. The ligation of an adapter sequence to the site of mismatch cleavage means that all of the sequences containing mismatches are forever directly and permanently ‘tagged’ with this adapter sequence without any a priori knowledge about the sample or any prior information concerning the DNA characterization of the original genomic content. The tagging allows these mismatched polynucleotides to be processed in a pool of other DNA sequences, since they can be addressed at any time, by using a primer pair complementary to the adapter. The ligation is performed using a DNA ligase, which catalyzes the formation of a phosphodiester bond between juxtaposed 5′ phosphate and 3′ hydroxyl termini in duplex DNA. The enzyme joins an adapter sequence to all blunt and protruding end termini of the fragmented DNA duplexes. Since in the present procedure the ends of the uncut fragments are not accessible for ligation, the adapter is only ligated to the site of mismatch cleavage. Accordingly, these fragments are readily available and accessible to high-throughput methods for analysis

Thus, one particular aspect of the present invention is a method for identifying such mutations by

(a) providing DNA from two sample pools of a subject, wherein a first sample pool is obtained from an diseased cell and a second sample pool is obtained from a normal cell;

(b) digesting each DNA sample pool to generate at least two DNA fragments;

(c) ligating a short oligonucleotide adapter to each fragment at a site of mismatch cleavage; and

(d) selectively amplifying and identifying the sequence differences between the two sample pools to identify a mutation.

A key aspect of the present invention is the ligation of an adapter polynucleotide, e.g., an oligonucleotide, to the site of mismatch cleavage

The invention also provides a method for screening a compound for effectiveness as an agonist of a polypeptide or protein having a mutation or SNP identified using the method of the invention. The method comprises: (a) exposing a sample comprising the polypeptide to a compound, and (b) detecting agonist activity in the sample. In one alternative, the invention provides a composition comprising an agonist compound identified by the method and a pharmaceutically acceptable excipient. In another alternative, the invention provides a method of treating a disease or condition associated with the SNP or mutation, comprising administering to a subject in need of such treatment the composition.

Additionally, the invention provides a method for screening a compound for effectiveness as an antagonist of a polypeptide or protein having a mutation or SNP identified using the method of the invention. The method comprises: (a) exposing a sample comprising the polypeptide to a compound, and (b) detecting antagonist activity in the sample. In one alternative, the invention provides a composition comprising an antagonist compound identified by the method and a pharmaceutically acceptable excipient. In another alternative, the invention provides a method of treating a disease or condition associated with overexpression of the protein or peptide comprising the SNP or mutation, comprising administering to a patient in need of such treatment the composition.

The invention further provides a method of screening for a compound that specifically binds to a polypeptide or protein having a mutation or SNP identified using the method of the invention. The method comprises: (a) combining the polypeptide with at least one test compound under suitable conditions, and (b) detecting binding of the polypeptide to the test compound, thereby identifying a compound that specifically binds to the polypeptide.

The invention further provides a method of screening for a compound that modulates the activity of a polypeptide or protein having a mutation or SNP identified using the method of the invention. The method comprises: (a) combining the polypeptide with at least one test compound under conditions permissive for the activity of the polypeptide, (b) assessing the activity of the polypeptide in the presence of the test compound, and (c) comparing the activity of the polypeptide in the presence of the test compound with the activity of the polypeptide in the absence of the test compound, wherein a change in the activity of the polypeptide in the presence of the test compound is indicative of a compound that modulates the activity of the polypeptide.

The invention further provides a method for screening a compound for effectiveness in altering expression of a target polynucleotide, wherein the target polynucleotide comprises a polynucleotide sequence encoding a peptide or protein having a mutation or SNP identified using the method of the invention. Such a method comprises: (a) exposing a sample comprising the target polynucleotide to a compound, and (b) detecting altered expression of the target polynucleotide.

The invention further provides a method for assessing toxicity of a test compound, said method comprising: (a) treating a biological sample comprising nucleic acids with the test compound; (b) hybridizing the nucleic acids of the treated biological sample with a probe comprising at least 20 contiguous nucleotides of a polynucleotide encoding a peptide or protein having a mutation or SNP identified using the method of the invention. Hybridization occurs under conditions whereby a specific hybridization complex is formed between the probe and a target polynucleotide in the biological sample. The target polynucleotide comprises a polynucleotide sequence encoding a peptide or protein having a mutation or SNP identified using the method of the invention; (c) quantifying the amount of hybridization complex; and (d) comparing the amount of hybridization complex in the treated biological sample with the amount of hybridization complex in an untreated biological sample, wherein a difference in the amount of hybridization complex in the treated biological sample is indicative of toxicity of the test compound.

A. Definitions

The present invention is described herein using several definitions, as set forth below and throughout the application.

As used herein, “about” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term.

A DNA or polynucleotide “coding sequence” is a DNA or polynucleotide sequence that is transcribed into mRNA and translated into a polypeptide in a host cell when placed under the control of appropriate regulatory sequences. The boundaries of the coding sequence are the start codon at the 5′ N-terminus and the translation stop codon at the 3′ C-terminus. A coding sequence can include prokaryotic sequences, cDNA from eukaryotic mRNA, genomic DNA sequences from eukaryotic DNA, and synthetic DNA sequences. A transcription termination sequence will usually be located 3′ to the coding sequence.

“DNA or polynucleotide sequence” is a heteropolymer of deoxyribonucleotides (bases adenine, guanine, thymine, cytosine). DNA or polynucleotide sequences encoding the proteins or polypeptides of this invention can be assembled from synthetic cDNA-derived DNA fragments and short oligonucleotide linkers to provide a synthetic gene that is capable of being expressed in a recombinant DNA expression vector. In discussing the structure of particular double-stranded DNA molecules, sequences may be described herein according to the normal convention of providing only the sequence in the 5′ to 3′ direction along the non-transcribed strand of cDNA.

“Recombinant expression vector or plasmid” is a replicable DNA vector or plasmid construct used either to amplify or to express DNA encoding the proteins or polypeptides of the present invention. An expression vector or plasmid contains DNA control sequences and a coding sequence. DNA control sequences include promoter sequences, ribosome binding sites, polyadenylation signals, transcription termination sequences, upstream regulatory domains, and enhancers. Recombinant expression systems as defined herein will express the proteins or polypeptides of the invention upon induction of the regulatory elements.

“Transformed host cells” refer to cells that have been transformed and transfected with exogenous DNA. Exogenous DNA may or may not be integrated (i.e., covalently linked) to chromosomal DNA making up the genome of the host cell. In prokaryotes and yeast, for example, the exogenous DNA may be maintained on an episomal element, such as a plasmid, or stably integrated into chromosomal DNA. With respect to eukaryotic cells, a stably transformed cell is one which is the exogenous DNA has become integrated into the chromosome. This stability is demonstrated by the ability of the eukaryotic cell lines or clones to produce via replication a population of daughter cells containing the exogenous DNA.

“Similarity” between two polypeptides is determined by comparing the amino acid sequence of one polypeptide to the sequence of a second polypeptide. An amino acid of one polypeptide is similar to the corresponding amino acid of a second polypeptide if it is identical or a conservative amino acid substitution. Conservative substitutions include those described in Dayhoff, M. O., ed., The Atlas of Protein Sequence and Structure 5, National Biomedical Research Foundation, Washington, D.C. (1978), and in Argos, P. (1989) EMBO J. 8:779-785. For example, amino acids belonging to one of the following groups represent conservative changes or substitutions:

-Ala, Pro, Gly, Gln, Asn, Ser, Thr:

-Cys, Ser, Tyr, Thr;

-Val, Ile, Leu, Met, Ala, Phe;

-Lys, Arg, His;

-Phe, Tyr, Trp, His; and

-Asp, Glu.

“Mammal” includes humans and domesticated animals, such as cats, dogs, swine, cattle, sheep, goats, horses, rabbits, and the like.

The term “agonist,” as used herein, refers to a molecule which, when bound to a polypeptide or protein comprising a SNP or mutation identified using the method of the invention, increases or prolongs the duration of the effect of the peptide or protein. Agonists may include proteins, nucleic acids, carbohydrates, or any other molecules which bind to and modulate the effect of the peptide or protein.

An “allele” or an “allelic sequence,” as these terms are used herein, is an alternative form of the gene encoding a polypeptide or protein comprising a SNP or mutation identified using the method of the invention. Alleles may result from at least one mutation in the nucleic acid sequence and may result in altered mRNAs or in polypeptides whose structure or function may or may not be altered. Any given natural or recombinant gene may have none, one, or many allelic forms. Common mutational changes which give rise to alleles are generally ascribed to natural deletions, additions, or substitutions of nucleotides. Each of these types of changes may occur alone, or in combination with the others, one or more times in a given sequence.

“Altered” nucleic acid sequences encoding a polypeptide or protein comprising a SNP or mutation identified using the method of the invention include those sequences with deletions, insertions, or substitutions of different nucleotides, resulting in a polynucleotide the same peptide or protein, or a polypeptide with at least one functional characteristic of the a polypeptide or protein comprising a SNP or mutation identified using the method of the invention. Deliberate amino acid substitutions may be made on the basis of similarity in polarity, charge, solubility, hydrophobicity, hydrophilicity, and/or the amphipathic nature of the residues, as long as the biological or immunological activity of the polypeptide or protein comprising a SNP or mutation identified using the method of the invention is retained. For example, negatively charged amino acids may include aspartic acid and glutamic acid, positively charged amino acids may include lysine and arginine, and amino acids with uncharged polar head groups having similar hydrophilicity values may include leucine, isoleucine, and valine; glycine and alanine; asparagine and glutamine; serine and threonine; and phenylalanine and tyrosine.

The terms “amino acid” or “amino acid sequence,” as used herein, refer to an oligopeptide, peptide, polypeptide, or protein sequence, or a fragment of any of these, and to naturally occurring or synthetic molecules. In this context, “fragments”, “immunogenic fragments”, or “antigenic fragments” refer to fragments of a polypeptide or protein comprising a SNP or mutation identified using the method of the invention which are preferably about 5 to about 15 about amino acids in length and which retain some biological activity or immunological activity of the polypeptide or protein comprising a SNP or mutation identified using the method of the invention. Where “amino acid sequence” is recited herein to refer to an amino acid sequence of a naturally occurring protein molecule, “amino acid sequence” and like terms are not meant to limit the amino acid sequence to the complete native amino acid sequence associated with the recited protein molecule.

“Amplification,” as used herein, relates to the production of additional copies of a nucleic acid sequence. Amplification is generally carried out using polymerase chain reaction (PCR) technologies well known in the art. (See, e.g., Dieffenbach, C. W. and G. S. Dveksler (1995) PCR Primer, a Laboratory Manual, Cold Spring Harbor Press, Plainview, N.Y., pp. 1-5.)

The term “antagonist,” as it is used herein, refers to a molecule which, when bound to a polypeptide or protein comprising a SNP or mutation identified using the method of the invention, decreases the amount or the duration of the effect of the biological or immunological activity of the peptide or protein. Antagonists may include proteins, nucleic acids, carbohydrates, antibodies, or any other molecules which decrease the effect of the polypeptide or protein comprising a SNP or mutation identified using the method of the invention.

As used herein, the term “antibody” refers to intact molecules as well as to fragments thereof, such as Fa, F(ab′)₂, and Fv fragments, which are capable of binding the epitopic determinant. Antibodies that bind to a polypeptide or protein comprising a SNP or mutation identified using the method of the invention can be prepared using intact polypeptides or using fragments containing small peptides of interest as the immunizing antigen. The polypeptide or oligopeptide used to immunize an animal (e.g., a mouse, a rat, or a rabbit) can be derived from the translation of RNA, or synthesized chemically, and can be conjugated to a carrier protein if desired. Commonly used carriers that are chemically coupled to peptides include bovine serum albumin, thyroglobulin, and keyhole limpet hemocyanin (KLH). The coupled peptide is then used to immunize the animal.

The term “antigenic determinant,” as used herein, refers to that fragment of a molecule (i.e., an epitope) that makes contact with a particular antibody. When a protein or a fragment of a protein is used to immunize a host animal, numerous regions of the protein may induce the production of antibodies which bind specifically to antigenic determinants (given regions or three-dimensional structures on the protein). An antigenic determinant may compete with the intact antigen (i.e., the immunogen used to elicit the immune response) for binding to an antibody.

The term “antisense,” as used herein, refers to any composition containing a nucleic acid sequence which is complementary to a specific nucleic acid sequence. The term “antisense strand” is used in reference to a nucleic acid strand that is complementary to the “sense” strand. Antisense molecules may be produced by any method including synthesis or transcription. Once introduced into a cell, the complementary nucleotides combine with natural sequences produced by the cell to form duplexes and to block either transcription or translation. The designation “negative” can refer to the antisense strand, and the designation “positive” can refer to the sense strand.

As used herein, the term “biologically active,” refers to a protein having structural, regulatory, or biochemical functions of a naturally occurring molecule. Likewise, “immunologically active” refers to the capability of the natural, recombinant, or synthetic polypeptide or protein comprising a SNP or mutation identified using the method of the invention, or of any oligopeptide thereof, to induce a specific immune response in appropriate animals or cells and to bind with specific antibodies.

The terms “complementary” or “complementarity,” as used herein, refer to the natural binding of polynucleotides under permissive salt and temperature conditions by base pairing. For example, the sequence “A-G-T” binds to the complementary sequence “T-C-A.” Complementarity between two single-stranded molecules may be “partial,” such that only some of the nucleic acids bind, or it may be “complete,” such that total complementarity exists between the single stranded molecules. The degree of complementarity between nucleic acid strands has significant effects on the efficiency and strength of the hybridization between the nucleic acid strands. This is of particular importance in amplification reactions, which depend upon binding between nucleic acids strands, and in the design and use of peptide nucleic acid (PNA) molecules.

A “composition comprising a given polynucleotide sequence” or a “composition comprising a given amino acid sequence,” as these terms are used herein, refer broadly to any composition containing the given polynucleotide or amino acid sequence. The composition may comprise a dry formulation, an aqueous solution, or a sterile composition. Compositions comprising polynucleotide sequences encoding a polypeptide or protein comprising a SNP or mutation identified using the method of the invention or fragments thereof may be employed as hybridization probes. The probes may be stored in freeze-dried form and may be associated with a stabilizing agent such as a carbohydrate. In hybridizations, the probe may be deployed in an aqueous solution containing salts (e.g., NaCl), detergents (e.g., SDS), and other components (e.g., Denhardt'ssolution, dry milk, salmon sperm DNA, etc.).

A “deletion,” as the term is used herein, refers to a change in the amino acid or nucleotide sequence that results in the absence of one or more amino acid residues or nucleotides.

The term “homology,” as used herein, refers to a degree of complementarity. There may be partial homology or complete homology. The word “identity” may substitute for the word “homology.” A partially complementary sequence that at least partially inhibits an identical sequence from hybridizing to a target nucleic acid is referred to as “substantially homologous.” The inhibition of hybridization of the completely complementary sequence to the target sequence may be examined using a hybridization assay (Southern or northern blot, solution hybridization, and the like) under conditions of reduced stringency. A substantially homologous sequence or hybridization probe will compete for and inhibit the binding of a completely homologous sequence to the target sequence under conditions of reduced stringency. This is not to say that conditions of reduced stringency are such that non-specific binding is permitted, as reduced stringency conditions require that the binding of two sequences to one another be a specific (i.e., a selective) interaction. The absence of non-specific binding may be tested by the use of a second target sequence which lacks even a partial degree of complementarity (e.g., less than about 30% homology or identity). In the absence of non-specific binding, the substantially homologous sequence or probe will not hybridize to the second non-complementary target sequence.

The phrases “percent identity” or “% identity” refer to the percentage of sequence similarity found in a comparison of two or more amino acid or nucleic acid sequences. Percent identity can be determined electronically, e.g., by using the MEGALIGN program (DNASTAR, Madison Wis.). This program can create alignments between two or more sequences according to different methods, e.g., the clustal method. (Higgins, D. G. and P. M. Sharp (1988) Gene 73:237-244.) The clustal algorithm groups sequences into clusters by examining the distances between all pairs. The clusters are aligned pairwise and then in groups. The percentage similarity between two amino acid sequences, e.g., sequence A and sequence B, is calculated by dividing the length of sequence A, minus the number of gap residues in sequence A, minus the number of gap residues in sequence B, into the sum of the residue matches between sequence A and sequence B, times one hundred. Gaps of low or of no homology between the two amino acid sequences are not included in determining percentage similarity. Percent identity between nucleic acid sequences can also be counted or calculated by other methods known in the art, such as the Jotun Hein method. (See e.g., Hein, J. (1990) Methods Enzymol. 183:626-645.) Identity between sequences can also be determined by other methods known in the art, e.g., by varying hybridization conditions.

The term “humanized antibody,” as used herein, refers to antibody molecules in which the amino acid sequence in the non-antigen binding regions has been altered so that the antibody more closely resembles a human antibody, and still retains its original binding ability.

“Hybridization,” as the term is used herein, refers to any process by which a strand of nucleic acid binds with a complementary strand through base pairing.

As used herein, the term “hybridization complex” as used herein, refers to a complex formed between two nucleic acid sequences by virtue of the formation of hydrogen bonds between complementary bases. A hybridization complex may be formed in solution (e.g., C₀t or R₀t analysis) or formed between one nucleic acid sequence present in solution and another nucleic acid sequence immobilized on a solid support (e.g., paper, membranes, filters, chips, pins or glass slides, or any other appropriate substrate to which cells or their nucleic acids have been fixed).

The words “insertion” or “addition,” as used herein, refer to changes in an amino acid or nucleotide sequence resulting in the addition of one or more amino acid residues or nucleotides, respectively, to the sequence found in the naturally occurring molecule.

“Immune response” can refer to conditions associated with inflammation, trauma, immune disorders, or infectious or genetic disease, etc. These conditions can be characterized by expression of various factors, e.g., cytokines, chemokines, and other signaling molecules, which may affect cellular and systemic defense systems.

The term “microarray,” as used herein, refers to an arrangement of distinct polynucleotides or oligonucleotides on a substrate, such as paper, nylon or any other type of membrane, filter, chip, glass slide, or any other suitable solid support.

The term “modulate,” as it appears herein, refers to a change in the activity of a polypeptide or protein comprising a SNP or mutation identified using the method of the invention. For example, modulation may cause an increase or a decrease in protein activity, binding characteristics, or any other biological, functional, or immunological properties of the polypeptide or protein comprising a SNP or mutation identified using the method of the invention.

The phrases “nucleic acid” or “nucleic acid sequence,” as used herein, refer to an oligonucleotide, nucleotide, polynucleotide, or any fragment thereof, to DNA or RNA of genomic or synthetic origin which may be single-stranded or double-stranded and may represent the sense or the antisense strand, to peptide nucleic acid (PNA), or to any DNA-like or RNA-like material. In this context, “fragments” refers to those nucleic acid sequences which are greater than about 60 nucleotides in length, and most preferably are at least about 100 nucleotides, at least about 1000 nucleotides, or at least about 10,000 nucleotides in length.

The terms “operably associated” or “operably linked,” as used herein, refer to functionally related nucleic acid sequences. A promoter is operably associated or operably linked with a coding sequence if the promoter controls the transcription of the encoded polypeptide. While operably associated or operably linked nucleic acid sequences can be contiguous and in reading frame, certain genetic elements, e.g., repressor genes, are not contiguously linked to the encoded polypeptide but still bind to operator sequences that control expression of the polypeptide.

The term “oligonucleotide,” as used herein, refers to a nucleic acid sequence of at least about 6 nucleotides to 60 nucleotides, preferably about 15 to about 30 nucleotides, and most preferably about 20 to about 25 nucleotides, which can be used in PCR amplification or in a hybridization assay or microarray. As used herein, the term “oligonucleotide” is substantially equivalent to the terms “amplimer,” “primer,” “oligomer,” and “probe,” as these terms are commonly defined in the art.

The term “sample,” as used herein, is used in its broadest sense. A biological sample suspected of containing nucleic acids encoding a polypeptide or protein comprising a SNP or mutation identified using the method of the invention, or fragments thereof, may comprise a bodily fluid; an extract from a cell, chromosome, organelle, or membrane isolated from a cell; a cell; genomic DNA, RNA, or cDNA, in solution or bound to a solid support; a tissue; a tissue print; etc.

As used herein, the terms “specific binding” or “specifically binding” refer to that interaction between a protein or peptide and an agonist, an antibody, or an antagonist. The interaction is dependent upon the presence of a particular structure of the protein, the antigenic determinant or epitope, recognized by the binding molecule. For example, if an antibody is specific for epitope “A,” the presence of a polypeptide containing the epitope A, or the presence of free unlabeled A, in a reaction containing free labeled A and the antibody will reduce the amount of labeled A that binds to the antibody.

As used herein, the term “stringent conditions” refers to conditions which permit hybridization between polynucleotide sequences and the claimed polynucleotide sequences. Suitably stringent conditions can be defined by, for example, the concentrations of salt or formamide in the prehybridization and hybridization solutions, or by the hybridization temperature, and are well known in the art. In particular, stringency can be increased by reducing the concentration of salt, increasing the concentration of formamide, or raising the hybridization temperature.

For example, hybridization under high stringency conditions could occur in about 50% formamide at about 37° C. to 42° C. Hybridization could occur under reduced stringency conditions in about 35% to 25% formamide at about 30° C. to 35° C. In particular, hybridization could occur under high stringency conditions at 42° C. in 50% formamide, 5× SSPE, 0.3% SDS, and 200 μg/ml sheared and denatured salmon sperm DNA. Hybridization could occur under reduced stringency conditions as described above, but in 35% formamide at a reduced temperature of 35° C. The temperature range corresponding to a particular level of stringency can be further narrowed by calculating the purine to pyrimidine ratio of the nucleic acid of interest and adjusting the temperature accordingly. Variations on the above ranges and conditions are well known in the art.

The term “substantially purified,” as used herein, refers to nucleic acid or amino acid sequences that are removed from their natural environment and are isolated or separated, and are at least about 60% free, preferably about 75% free, and most preferably about 90% free from other components with which they are naturally associated.

A “substitution,” as used herein, refers to the replacement of one or more amino acids or nucleotides by different amino acids or nucleotides, respectively.

All other technical terms used herein have the same meaning as is commonly used by those skilled in the art to which the present invention belongs.

B. Identification of Genome-Wide Mutations and SNPS

The methods provided herein entail the use of differential expression analysis to identify mutations that are associated with cancerous cells. Generally, the differential expression methods provided herein entail manipulating nucleic acids obtained from cancerous and non-cancerous cells from the same individual. The differential expression analysis methods identify on a molecular level RNA or cDNA molecules (“tags”) absent from or present at relatively lower amounts in “driver RNA” or “driver cDNA” prepared from “reference cells” (cells which should not be identified by the probe sequence, e.g., non-cancerous cells), and present (at relatively higher amounts) in “tester RNA” or “tester cDNA” prepared from target cells (cells which should be identified by the probe sequence, e.g., cancerous cells).

A variety of methods are known in the art for identifying differentially expressed nucleic acids that can be used to identify mutations specific to cancerous cells. “Differential expression,” as the term is used herein, is understood to refer to both quantitative as well as qualitative differences in expression patterns, e.g., of a gene or genes, between target cells (e.g., cancer cells) and reference cells (e.g., normal cells). That is, differential expression are useful assays for detecting the presence of genomic DNA as well as expression levels of RNA.

Methods of differential expression are well-known to one skilled in the art, and include but are not limited to differential display, serial analysis of gene expression (SAGE), nucleic acid array technology, suppression subtractive hybridization, proteome analysis, mass-spectrometry of two-dimensional protein gels. The methods of gene expression profiling are exemplified by the following references describing differential display (Liang and Pardee, 1992, Science 257:967-971), proteome analysis (Humphery-Smith et al., 1997, Electrophoresis 18:1217-1242; Dainese et al., 1997, Electrophoresis 18:432-442), SAGE (Velculescu et al., 1995, Science 270:484-487), suppression subtractive hybridization (Diatchenko, et al. 1996, Proc. Natl. Acad. Sci. U.S.A. 93:12:6025-30), and hybridization-based methods of using nucleic acid arrays (Heller et al., 1997, Proc. Natl. Acad. Sci. U.S.A. 94:2150-2155; Lashkari et al., 1997, Proc. Natl. Acad. Sci. U.S.A. 94:13057-13062; Wodicka et al., 1997, Nature Biotechnol. 15:1259-1267). All such methods are encompassed by the present invention.

In one embodiment, suppression subtractive hybridization is used to identify fetal cell tags. The principle of subtractive hybridization is that cDNAs common to both the target (e.g., cancer) cells and reference (e.g., normal) cells are selected by hybridizing to each other, leaving differentially expressed cDNA clones. See Diatchenko et al., 1996, Proc. Natl. Acad. Sci. U.S.A. 93:12:6025-30. Suppression subtractive hybridization removes commonly expressed cDNAs from the experimental and control cDNA pools and thereby enriches for differentially expressed genes.

Suppression subtractive hybridization, which utilizes a combination of subtractive hybridization and polymerase chain reaction technology, is well known in the art and may even be performed using commercially available kits (Diatchenko et al., 1996, Proc. Natl. Acad. Sci USA 93(12):6025-6030; PCR-select cDNA Subtraction Kit (Clontech), which is based on methods described in U.S. Pat. No. 5,565,340). Generally, mRNA is isolated from the tissue or cell type which produces the tag sequences (e.g., cell/tissue specific or selected mRNA's), then converted into cDNA using any convenient method for production of double-stranded cDNA. cDNA (or a portion of the cDNA) from the tissue or cell type which produces the probe sequences (“tester cDNA”) is digested with a restriction endonuclease to produce appropriate ‘sticky ends’ (single stranded overhangs to which other nucleic acids, such as adaptors, may be annealed), split into two portions (a “first portion” and a “second portion”), and the two portions are modified by the addition of different adaptors of known sequence (e.g., the first portion is modified by addition of a first adaptor and the second portion is modified by the addition of a second, different adaptor). “Driver cDNA” prepared from “reference cells” (e.g., cells which should not be identified by the probe sequence, such as non-cancerous cells) is separately mixed with the modified first and second portions of tester cDNA, and each mixture is denatured and allowed to anneal. Each resulting mixture comprises single-stranded tester cDNA, homoduplex tester cDNA, heteroduplex tester/driver cDNA, single stranded driver cDNA, and homoduplex driver cDNA. These mixtures are combined, along with an additional portion of denatured driver cDNA, and allowed to anneal, creating a complex mixture comprising single stranded tester cDNA and portion 1 and portion 2 tester cDNA, homoduplex driver cDNA and portion 1 and portion 2 tester cDNA, heteroduplex portion 1 tester/driver cDNA, heteroduplex portion 2 tester/driver cDNA and heteroduplex portion 1/portion 2 tester cDNA. The ends of the duplex cDNA's are “filled in” using a template-driven reaction (e.g., using DNA polymerase), then amplified using a template-driven amplification process such as the polymerase chain reaction and two primers, a first primer which will anneal to the first adaptor, and a second primer which will anneal to the second adaptor. Only heteroduplex portion 1/portion 2 tester cDNA will be geometrically amplified by the amplification reaction. The end result of SSH is a population of amplified sequences which are derived from RNAs more prevalent in the tester sample than the driver sample.

The SSH process may be reiterated using a different driver cDNA. Reiteration of the SSH process simply requires that the amplified product from the previous round of SSH be digested with a restriction enzyme to produce appropriate sticky ends to the amplified double stranded DNA, preferably using the same restriction endonuclease as in the previous round(s) of SSH. The digested DNA is then split into two portions, modified by the separate addition of different adaptors, and processed. SSH may be reiterated as many times as desired, with any number of driver cDNA samples.

Driver cDNA may be prepared from a variety of sources, including, but not limited to, samples of tumor tissues displaying active cell growth and division.

The product of the SSH reaction can be cloned into a suitable vector, thereby constituting a subtracted library from which individual candidate cDNA can be regenerated and validated. The use of the SSH technique permits the preparation of libraries corresponding to a number of fetal cell/reference cell (tester/driver) combinations to determine which combinations of cell types and collection times yield the richest proportion of valid clones.

In one embodiment, the oligonucleotide adapter that is ligated to the site of mismatch cleavage therefore includes an recognition sequence for a type IIS endonuclease, which recognizes the sequence and cleaves at a defined distance apart. For instance, the MmeI enzyme cleaves at 20 base pair intervals. Hence, all of the fragments are standardized to a length of 20 bp plus the adapter length. Moreover, this site creates a new ligation site for a second adapter that may be required for PCR amplification.

C. Sequence Analysis

Methods of alignment of sequences for comparison are well-known in the art. Optimal alignment of sequences for comparison may be conducted by the local homology algorithm of Smith and Waterman, Adv. Appl. Math. 2: 482 (1981); by the homology alignment algorithm of Needleman and Wunsch, J. Mol. Biol. 48: 443 (1970); by the search for similarity method of Pearson and Lipman, Proc. Natl. Acad. Sci. 85: 2444 (1988); by computerized implementations of these algorithms, including, but not limited to: CLUSTAL in the PC/Gene program by Intelligenetics, Mountain View, Calif.; GAP, BESTFIT, BLAST, FASTA, and TFASTA in the Wisconsin Genetics Software Package, Genetics Computer Group (GCG), 575 Science Dr., Madison, Wis., USA; the CLUSTAL program is well described by Higgins and Sharp, Gene 73: 237-244 (1988); Higgins and Sharp, CABIOS 5: 151-153 (1989); Corpet et al., Nucleic Acids Research 16: 10881-90 (1988); Huang et al., Computer Applications in the Biosciences 8: 155-65 (1992), and Pearson et al., Methods in Molecular Biology 24: 307-331 (1994).

The BLAST family of programs which can be used for database similarity searches includes: BLASTN for nucleotide query sequences against nucleotide database sequences; BLASTX for nucleotide query sequences against protein database sequences; BLASTP for protein query sequences against protein database sequences; TBLASTN for protein query sequences against nucleotide database sequences; and TBLASTX for nucleotide query sequences against nucleotide database sequences. See Current Protocols in Molecular Biology, Chapter 19, Ausubel, et al., Eds., Greene Publishing and Wiley-Interscience, New York (1995); Altschul et al., J. Mol. Biol., 215:403-410 (1990); and, Altschul et al., Nucleic Acids Res. 25:3389-3402 (1997).

Software for performing BLAST analyses is publicly available, e.g., through the National Center for Biotechnology Information (http://www.ncbi.nlm.nih.gov/). This algorithm involves first identifying high scoring sequence pairs (HSPs) by identifying short words of length W in the query sequence, which either match or satisfy some positive-valued threshold score T when aligned with a word of the same length in a database sequence. T is referred to as the neighborhood word score threshold. These initial neighborhood word hits act as seeds for initiating searches to find longer HSPs containing them. The word hits are then extended in both directions along each sequence for as far as the cumulative alignment score can be increased. Cumulative scores are calculated using, for nucleotide sequences, the parameters M (reward score for a pair of matching residues; always >0) and N (penalty score for mismatching residues; always <0). For amino acid sequences, a scoring matrix is used to calculate the cumulative score. Extension of the word hits in each direction are halted when: the cumulative alignment score falls off by the quantity X from its maximum achieved value; the cumulative score goes to zero or below, due to the accumulation of one or more negative-scoring residue alignments; or the end of either sequence is reached. The BLAST algorithm parameters W, T, and X determine the sensitivity and speed of the alignment. The BLASTN program (for nucleotide sequences) uses as defaults a wordlength (W) of 11, an expectation (E) of 10, a cutoff of 100, M=5, N=−4, and a comparison of both strands. For amino acid sequences, the BLASTP program uses as defaults a wordlength (W) of 3, an expectation (E) of 10, and the BLOSUM62 scoring matrix (see Henikoff & Henikoff (1989) Proc. Natl. Acad. Sci. USA 89:10915).

In addition to calculating percent sequence identity, the BLAST algorithm also performs a statistical analysis of the similarity between two sequences (see e.g., Karlin & Altschul, Proc. Nat'l. Acad. Sci. USA 90:5873-5877 (1993)). One measure of similarity provided by the BLAST algorithm is the smallest sum probability (P(N)), which provides an indication of the probability by which a match between two nucleotide or amino acid sequences would occur by chance.

Multiple alignment of the sequences can be performed using the CLUSTAL method of alignment (Higgins and Sharp (1989) CABIOS. 5:151-153) with the default parameters (GAP PENALTY=10, GAP LENGTH PENALTY=10). Default parameters for pairwise alignments using the CLUSTAL method are KTUPLE 1, GAP PENALTY=3, WINDOW=5 and DIAGONALS SAVED=5.

The following running parameters are preferred for determination of alignments and similarities using BLASTN that contribute to the E values and percentage identity for polynucleotide sequences: Unix running command: blastall -p blastn -d embldb -e 10 -G0 -E0 -r 1 -v 30 -b 30 -i queryseq -o results; the parameters are: -p Program Name [String]; -d Database [String]; -e Expectation value (E) [Real]; -G Cost to open a gap (zero invokes default behavior) [Integer]; -E Cost to extend a gap (zero invokes default behavior) [Integer]; -r Reward for a nucleotide match (blastn only) [Integer]; -v Number of one-line descriptions (V) [Integer]; -b Number of alignments to show (B) [Integer]; -i Query File [File In]; and -o BLAST report Output File [File Out] Optional.

The “hits” to one or more database sequences by a queried sequence produced by BLASTN, FASTA, BLASTP or a similar algorithm, align and identify similar portions of sequences. The hits are arranged in order of the degree of similarity and the length of sequence overlap. Hits to a database sequence generally represent an overlap over only a fraction of the sequence length of the queried sequence.

The BLASTN, FASTA and BLASTP algorithms also produce “Expect” values for alignments. The Expect value (E) indicates the number of hits one can “expect” to see over a certain number of contiguous sequences by chance when searching a database of a certain size. The Expect value is used as a significance threshold for determining whether the hit to a database, such as the preferred EMBL database, indicates true similarity. For example, an E value of 0.1 assigned to a polynucleotide hit is interpreted as meaning that in a database of the size of the EMBL database, one might expect to see 0.1 matches over the aligned portion of the sequence with a similar score simply by chance. By this criterion, the aligned and matched portions of the polynucleotide sequences then have a probability of 90% of being the same. For sequences having an E value of 0.01 or less over aligned and matched portions, the probability of finding a match by chance in the EMBL database is 1% or less using the BLASTN or FASTA algorithm.

According to one embodiment, “variant” polynucleotides, with reference to each of the polynucleotides of the present invention, preferably comprise sequences having the same number or fewer nucleic acids than each of the polynucleotides of the present invention and producing an E value of 0.01 or less when compared to the polynucleotide of the present invention. That is, a variant polynucleotide is any sequence that has at least a 99% probability of being the same as the polynucleotide of the present invention, measured as having an E value of 0.01 or less using the BLASTN, FASTA, or BLASTP algorithms set at parameters described above.

D. Applications

Identification of a SNP or mutation related to cancer can be used to identify diagnostic methods and treatments for cancer. For example, expression of the peptide or protein correlated with the region of the genome where the SNP or mutation is located can be compared between the cancer subject and the healthy subject, to identify potential therapies.

Identification of a mutation related to a disease in the regulatory elements that can be used for diagnosis or treatment by a blocking agent specifically preventing binding of proteins to that mutation.

All diseases that can be inherited directly or for which a predisposition can be inherited, rely on a genetic change in the nuclear or mitochondrial genome. Hence the present invention contemplates genome-wise mutation detection of any such inheritable genetic disease, such as Parkinson's disease, Alzheimer disease, myocardial infarction and type 2 diabetes.

The present invention also contemplates detection of mutations due to epigenetic changes of DNA. Epigenetic inheritance is the transmission of genetic details a cell to a descendant cell without those details being encoded in the nucleotide sequence of the gene. Dividing fibroblasts, for example, produce new fibroblasts even though their genome is identical to that of all other cells in the organism. That is, the fibroblast cell produces a fibroblast cell type and not some other cell type. Quantitative genetic studies in mammals and birds can reveal maternal effects, which is a form of epigenetic transmission, from one generation to the next. Environmental factors can affect the way genes are expressed in the offspring to give rise to new or altered traits. Thus, epigenetic inheritance allow cells of different phenotype, but identical genotype, to transmit their phenotype to their offspring, even when the phenotype-inducing stimuli are absent.

The present invention therefore contemplates detection of epigenetic mutations. A method of the present invention may therefore include an additional step, such as treating genomic DNA with sodium bisulphite and then the resulting modified DNA can be analyzed as described in the claims. Sodium bisulphite lowers the melting temperature of very GC-rich nucleotide sequences, thereby rendering them amenable to denaturing gradient gel electrophoresis analysis and PCR.

The following examples are set forth as representative of specific and preferred embodiments of the present invention. These examples are not to be construed as limiting the scope of the invention in any manner. It should be understood that many variations and modifications can be made while remaining within the spirit and scope of the invention. All references identified herein, including U.S. patents, are hereby expressly incorporated by reference.

### EXAMPLE 1

### Oligonucleotide Synthesis

Oligonucleotides were synthesized by biomers.net GmbH (Ulm, Germany). Phusion polymerase and HF buffers were obtained from New England Biolabs (Ipswich, Mass., USA). Transgenomic SURVEYOR™ Mutation Detection Kit and Optimase buffer was obtained from Transgenomic Ltd., (Omaha, Nebr., USA).

### EXAMPLE 2

### Generation of DNA Control Fragments and Formation of Heteroduplex

Two 632 bp PCR products from the Transgenomic SURVEYOR™ Mutation Detection Kit were amplified by PCR. Both strands differ in base 417, which is cytosine in one PCR product and a guanine in the other product, so that upon cleavage, two products are generated, with lengths of 215 bp and 417 bp, respectively.

PCR was performed in 100 μl volumes in 96-well polypropylene PCR plates (Steinbrenner Laborsysteme GmbH, Wiesenbach, Germany) with the following primers:

Primer 1 (first three bases 5′ consisted of phosphothioate nucleotides):

(SEQ ID NO. 1)
5′- acacctgatcaagcctgttcatttgattac -3′

Primer 2 (first three bases 5′ consisted of phosphothioate nucleotides):

| | |
|---|---|
| 5′- cgccaaagaatgatctgcggagctt -3′ | (SEQ ID NO. 2) |

The composition of the reaction was 1× HF-Buffer, 0.2 mM of each dNTP, 0.5 μM of each primer, 1 U Phusion Polymerase and 14.5 pg control plasmid C or 18.5 pg control plasmid G. Reactions were performed in a PTC-200 Thermocycler (Biorad Laboratories, Munich, Germany) at the following temperatures: denaturation at 95° C. for 5 mM; 35 cycles of 95° C. for 30 s, 66° C. for 30 s, 72° C. 60 s; a final elongation step at 72° C. for 5 min and cooling down to 4° C. After PCR, products were checked on a gel for purity and yield and equal portions of both batches were mixed. Heteroduplexes were formed by cycling in a PTC-200 with the following program: 95° C. for 2 min, 70° C. for 2 min, cooling down at 0.1° C./s to 60° C., 60° C. for 10 min, cooling down at 0.1° C./s to 50° C., 50° C. for 10 mM, cooling down to 4° C. Then a purification was performed using QIAquick PCR Purification Kit (Qiagen GmbH, Hilden) as recommended by the manufacturer and the concentration of the DNA was measured on a Nanodrop ND-1000 (Peqlab Biotechnologie GmbH, Erlangen). Concentrations of the henteroduplexes were adjusted to 150 ng/μl.

### EXAMPLE 3

### Heteroduplex Digestion

Digestions were performed in 5 μl reactions consisting of 2 μl of heteroduplex (300 ng), 1 μl of Surveyor nuclease, 0,5 μl 10× Buffer (200 mM Tris, pH 7.5, 250 mM KCl, 100 mM MgCl₂) and 1.5 μl H2O. The digestions were incubated for 20 min at 42° C.

### EXAMPLE 4

### Preparation of Adapters

Adapters were prepared from the following two oligonucleotides:

(SEQ ID NO. 3)
5′- ggtcggactccgatcagatcgtcctgtgtgaaattgttatccgc
tgcg -3′
(SEQ ID NO. 4)
5′- cgatctgatcggagtccgaccn -3′

Both oligonucleotides were diluted to a final concentration of 100 μM in 1× Optimase buffer and annealed in a PTC-200 Thermocycler at the following temperatures: 95° C. for 2 min, 70° C. for 2 min, cooling down at 0.1° C./s to 60° C. 60° C. for 10 min, cooling down at 0.1° C./s to 50° C., 50° C. for 10 min, cooling down at 0.1° C./s to 45° C., 45° C. for 10 min, cooling down to 4° C.

### EXAMPLE 5

### Ligation of Heteroduplex and Detection

Ligations were performed in 30 μl reactions consisting of 2 μl digested heteroduplex, 5 μl of annealed adapter, 3 μl 10× Roche Ligation Buffer, 1 μl T4 DNA ligase (1 U/μl) and 19 μl of H2O. Ligation was performed at 16° C. overnight.

For detection a PCR was performed in 50 μl volumes in 96-well polypropylene PCR plates (Steinbrenner Laborsysteme GmbH, Wiesenbach, Germany) with the following primers:

Primer 1 (first three bases 5′ consisted of phosphothioate nucleotides):

(SEQ ID NO. 5)
5′- acacctgatcaagcctgttcatttgattac -3′

Primer 3:

| | |
|---|---|
| 5′- agcggataacaatttcacacagga -3′ | (SEQ ID NO. 6) |

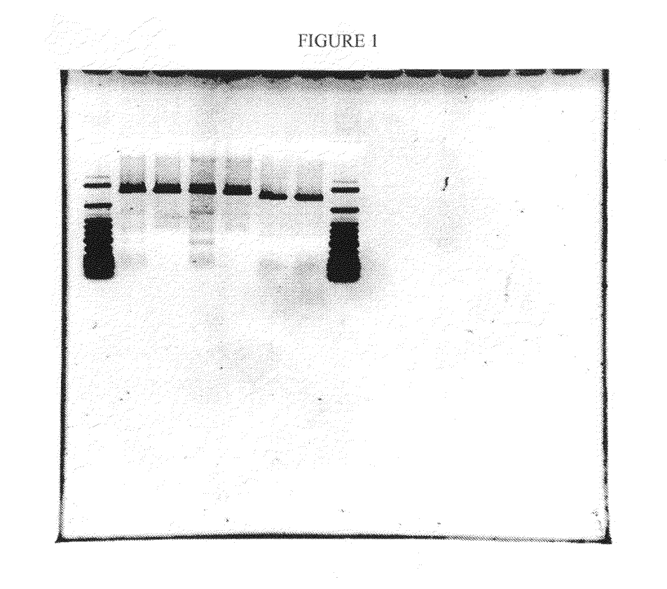

The composition of the reaction was 1× HF-Buffer, 0.2 mM of each dNTP, 0.5 μM of each primer, 0,5 U Phusion Polymerase and 0.5 μl of a 1:1000 dilution of the ligation reaction. The reactions were performed in a PTC-200 Thermocycler (Biorad Laboratories, Munich, Germany) at the following temperatures: denaturation at 95° C. for 5 min; 35 cycles of 95° C. for 30 s, 50° C. for 30 s, 72° C. 60 s; a final elongation step at 72° C. for 5 min and cooling down to 4° C. In addition, a second PCR using the same reaction conditions was performed with the exception that Primer 1 and Primer 2 were applied. The resulting PCR products were checked on a gel for purity (see FIG. 1).

### EXAMPLE 6

### CELI Assay

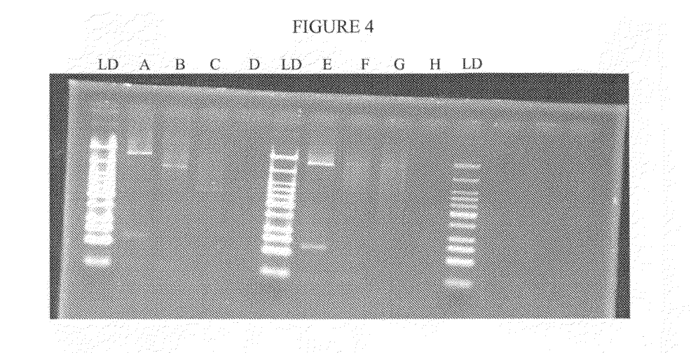

The following reagents, recipes, and methods for conducting PCR amplification experiments proved useful in creating a CELI assay useful for detecting heteroduplexes with primers and adapter specific primers. See also FIG. 4 for gel-depicted results of those PCR amplification experiments.

With respect to FIG. 4, the gel shows DNA fragments originating from a PCR after Cell digestion and is divided into two parts, one comprising section A-D and one comprising E-H. The first part (A-D) shows the situation for a fragment containing the mismatch, the second part (E-H) shows the situation for a fragment not containing a mismatch.

The first lane of both parts illustrates an amplification of the uncut fragment (632 bp) with the same primers used for initial amplification. This lane shows that the primers are working and are specifically amplifying the fragment. Moreover it shows that not all fragments were digested by the Cell enzyme, since in this case no band could appear in this size. However, a complete digestion of the fragment is not possible and not envisaged, since a few digested transcripts are sufficient for the subsequent analysis.

The second and third lane shows the amplification of the digestion products of CelI digestion (459 bp and 261 bp). For that, an adapter was ligated to the site of Cell digestion and two primers were used for amplification, one hybridizing to the end of the original fragment and one adapter-specific. Those lanes proof the successful digestion and the specific ligation of the adapter, since the exponential amplification was only possible with fragments carrying the adapter sequence. Without the successful adapter ligation, only a linear amplification would have been possible. However, this would have also yielded a band of the same size as the first lane (as can be seen in the weak band of lane F and G).

The last lane is a negative control just using the primer sequence complimentary to the newly introduced adapter sequence. This lane should show not exponential amplification unless the adapter is ligated to both sited of the fragments. Hence this lane shows that the adapter only ligated to the site of mismatch cleavage.

### (a) Reagents

i. SURVEYOR™ Mutation Detection Kit for Standard Gel Electrophoresis (Transgenomic)
ii. Phusion Polymerase (NEB)
iii. T4 Polymerase (NEB)
iv. Low Molecular Weight DNA Ladder (NEB)
v. Qiagen PCR purification kit (Qiagen)
vi. Dynabeads® MyOne™ Streptavidin Cl (Invitrogen)

### (b) Solutions

Transgenomic Buffer: 20 mM Tris HCl pH 7.5
25 mM KCl
10 mM MgCl₂

2× Binding & Washing (B&W) Buffer: 10 mM Tris-HCl (pH 7.5)
1 mM EDTA
2.0 M NaCl

### (c) Primers

Cel-Adapter (having a blunt end):

(SEQ ID NO. 7)
Cell-Linker Ia:
5′ gttggatctcgcggccgctcctgtgtgaaattgttatccgctgcg
3′ (5' Phosphate)
(SEQ ID NO. 8)
Cell-Linker Ib blunt:
5′gccgcgagatccaac 3′
(SEQ ID NO. 9)
Control Primer FWD:
5′ acacctgatcaagcctgttcatttgattac 3′
(SEQ ID NO. 10)
Control Primer REV:
5′ cgccaaagaatgatctgcggagctt 3′
(SEQ ID NO. 11)
P Cel Ia REV:
5′gcagcggataacaatttcacacaggagcgg 3′
(SEQ ID NO. 12)
Control Primer Biotin FWD:
5′ acacctgatcaagcctgttcatttgattac 3′ (3′ Biotin)
(SEQ ID NO. 13)
Control Primer Biotin REV:
5′ cgccaaagaatgatctgcggagctt 3′ (3′ Biotin)

### (d) Method

(i) Annealing of adapters:
1) Mix equal ratios of Cell-Linker 1a and Cell-Linker 1b blunt (final concentration: 50 pmol/μl oligo in 10 mM Tris, 1mM MgCl₂)
2) Anneal:
   95° C. 2:00
   70° C. 2:00
ramp with 0.1° C./s to 60° C. 10:00
ramp with 0.1° C./s to 50° C. 10:00
ramp with 0.1° C./s to 45° C. 10:00
cool to 4° C.

(ii) Amplification of control from SURVEYOR kit:

### 1) Mix:

0.5 μl 5′-Primer (Control Primer Biotin FWD, 100 pmol/μl)
0.5 μl 3′-Primer (Control Primer Biotin REV; 100 pmol/μl)
20 μl 5× HF Buffer
2 μl dNTP-mix (10 mM)
0.5 μl Phusion
1 μl 1:1000 Control Plasmid C out of kit (original conc.=5 ng/μl)
75.5 μl ddH2O
   2) Mix: 0.5 μl 5′-Primer (Control Primer Biotin FWD, 100 pmol/μl)
0.5 μl 3′-Primer (Control Primer Biotin REV; 100 pmol/μl)
20 μl 5× HF Buffer
2 μl dNTP-mix (10 mM)
0.5 μl Phusion
1 μl 1:1000 Control Plasmid G out of kit (original conc.=5 ng/μl)
75.5 μl ddH2O
   3) Run PCR program:
95° C. 0:30
66° C. 0:30
72° C. 1:00
repeat 37×
72° C. 5:00
4° C. 0:01
   4) Check on gel and perform purification with Qiagen PCR purification kit and elute with H2O.
   5) Produce hetero- and homoduplex by annealing of equal ratios of PCR puducts with G and G as well as C and G at: 95° C. 2 min
ramp with 2° C./s to 95° C. to 85° C.
ramp with 0.1° C./s to 85° C. to 25° C.
   4° C. hold
      6) (iii) Coating of beads with homo- and heteroduplex:
      1) Wash dynabeads streptavidin C1 twice in 2× B&W Buffer and resuspend in twice the original volume.

### 2) Mix:

1 mg beads (resuspendend in 200 μl 2× B&W)
   5 μg hetero- or homoduplex
   add H₂O up to a total volume of 400 μl
      3) Incubate for 15 min at room temperature.
      4) Wash 2-3× in 1× B&W and resuspend in 25 μl EB from Qiagen kit.

7) (iv) Cell Digest

### 1) Mix:

1 μl Bead-bound heteroduplex (200 ng)
1 μl Surveyor nuclease
1 μl Nuclease enhancer
0.5 μl 1× Transgenomic Buffer
1.5 μl H2O
1 μl Bead-bound homoduplex (200 ng)
1 μl Surveyor nuclease
1 μl Nuclease enhancer
0.5 μl 10× Transgenomic Buffer
1.5 μl H2O

### 2) Incubate for 20 min at 42° C.

3) Exchange reaction mix to 5μμl EB.

(v) T4 polymerase blunting and ligation of adapter

### 4) Mix:

5 μl Bead-bound digested homo-/heteroduplex
1 μl dNTPs (1 mM)
0.25 μl T4 DNA polymerase (1 U)
2 μl 2× T4 DNA polymerase buffer
1.8 μl H2O

### 5) Incubate for 20 min at 11° C.

6) Exchange reaction mix to 5 μl EB.

### 7) Mix:

5 μl bead-bound blunted homo-/heteroduplex
10 μl Cell Adapter
3 μl 10× Roche T4 Ligase Buffer
1 μl T4 DNA Ligase (5 U)
11 μl PEG 8000 (o.c. 40%)
   3) Incubate at 16° C. overnight.

(vii) Control PCR

### 1) Perform PCR:

A+E: 0.2 μl 5′-Primer (Control Primer FWD; 100 pmol/μl)
0.2 μl 3″-Primer (Control Primer REV; 100 pmol/μl)
4 μl 5× HF Buffer
0.4 μl dNTP-mix (10 mM)
0.1 μl Phusion
0.5 μl 1:100 beads
14.5 μl ddH2O
   B+F 0.2 μl 5′-Primer (Control Primer FWD; 100 pmol/μl)
0.1 μl 3′-Primer (Control Primer REV; 100 pmol/μl)
4 μl 5× HF Buffer
0.4 μl dNTP-mix (10 mM)
0.2 μl Phusion
0.5 μl 1:100 beads
14.5 μl ddH2O
   C+G 0.2 μl 5″-Primer (Control Primer FWD; 100 pmol/μl)
0.2 μl 3′-Primer (P Cell Ia REV; 100 pmol/μl)
4 μl 5× HF Buffer
0.4 μl dNTP-mix (10 mM)
0.1 μl Phusion
0.5 μl 1:100 beads
14.5 μl ddH2O
   D+H 0.2 μl 3′-Primer (P Cell Ia REV; 100 pmol/μl)
4 μl 5× HF Buffer
0.4 μl dNTP-mix (10 mM)
0.1 μl Phusion
0.5 μμl 1:100 beads
14.7 μl ddH2O
   2) Overlay with 2 μl of mineral oil.
   3) Run PCR program:
95° C. 5:00
95° C. 0:30
72° C. 1:00
repeat 20×
72° C. 5:00
4° C. 0:01

It will be apparent to those skilled in the art that various modifications and variations can be made in the methods and compositions of the present inventions without departing from the spirit or scope of the invention. Thus, it is intended that the present invention cover the modification and variations of the invention provided they come within the scope of the appended claims and their equivalents.

What is claimed is:

1. A method for identifying a genome-wide mutation, comprising:
(a) providing DNA from two sample pools of a subject, wherein a first sample pool is obtained from an diseased cell and a second sample pool is obtained from a normal cell;
(b) digesting each DNA sample pool to generate at least two DNA fragments;
(c) ligating a short oligonucleotide adapter to each fragment at a site of mismatch cleavage; and
(d) selectively amplifying and identifying the sequence differences between the two sample pools to identify a mutation.

2. The method of claim 1, wherein the diseased cell is a cancer cell.

3. The method of claim 1, wherein the selectively amplifying and identifying means are selected from the group consisting of differential display, representational differential analysis, suppressive subtraction hybridization, serial analysis of gene expression, gene expression microarray, nucleic acid chip technology, and direct sequencing.

4. The method of claim 3, wherein the selectively amplifying and identifying means is suppressive subtraction hybridization.

5. The method of claim 1, wherein the individual is a mammal, plant, fungus, reptile, bird, fish, insect, bacterium, or virus.

6. The method of claim 5, wherein the mammal is selected from the group consisting of a human, dog, cat, cattle, pig, sheep, rat, mouse, guinea pig, hamster, horse, cow, chicken, and rodent.

7. The method of claim 6, wherein the mammal is a human.

8. A method for identifying a oncogenic mutation comprising:
(a) providing DNA from two sample pools of a subject, wherein a first sample pool is obtained from a cancer cell and a second sample pool is obtained from a normal cell;
(b) digesting each DNA sample pool to generate DNA fragments;
(c) ligating a short oligonucleotide adapter to each fragment at a site of mismatch cleavage; and
(d) selectively amplifying and identifying the sequence differences between the two sample pools to identify an oncogenic mutation.

9. A method for identifying a genome-wide mutation, comprising:
(a) providing DNA from two sample pools of a subject, wherein a first sample pool is obtained from an diseased cell and a second sample pool is obtained from a normal cell;
(b) digesting each DNA sample pool to generate at least two DNA fragments;
(c) ligating a short oligonucleotide adapter carrying a recognition site for a type IIS restriction endonuclease to each fragment at a site of mismatch cleavage;
(d) digesting all fragments with a type IIS restriction endonuclease and ligating a second short oligonucleotide adapter to the site of IIS restriction endonuclease cleavage; and
(e) selectively amplifying and identifying the sequence differences between the two sample pools to identify a mutation.

10. A method for identifying a genome-wide mutation, comprising:
(a) providing DNA from two sample pools of a subject, wherein a first sample pool is obtained from an diseased cell and a second sample pool is obtained from a normal cell;
(b) digesting each DNA sample pool with Cell to generate at least two DNA fragments;
(c) ligating a short oligonucleotide adapter to each fragment at a site of mismatch cleavage; and
(d) selectively amplifying and identifying the sequence differences between the two sample pools to identify a mutation.


SEQUENCE LISTING (13 sequences)

SEQ ID NO: 1 - DNA, 30 bp, Artificial Sequence
  Description of Artificial Sequence Synthetic primer
acacctgatcaagcctgttcatttgattac

SEQ ID NO: 2 - DNA, 25 bp, Artificial Sequence
  Description of Artificial Sequence Synthetic primer
cgccaaagaatgatctgcggagctt

SEQ ID NO: 3 - DNA, 48 bp, Artificial Sequence
  Description of Artificial Sequence Synthetic primer
ggtcggactccgatcagatcgtcctgtgtgaaattgttatccgctgcg

SEQ ID NO: 4 - DNA, 22 bp, Artificial Sequence
  Description of Artificial Sequence Synthetic primer
cgatctgatcggagtccgaccn

SEQ ID NO: 5 - DNA, 30 bp, Artificial Sequence; identical to SEQ ID NO: 1
  Description of Artificial Sequence Synthetic primer

SEQ ID NO: 6 - DNA, 24 bp, Artificial Sequence
  Description of Artificial Sequence Synthetic primer
agcggataacaatttcacacagga

SEQ ID NO: 7 - DNA, 45 bp, Artificial Sequence
  Description of Artificial Sequence Synthetic primer
gttggatctcgcggccgctcctgtgtgaaattgttatccgctgcg

SEQ ID NO: 8 - DNA, 15 bp, Artificial Sequence
  Description of Artificial Sequence Synthetic primer
gccgcgagatccaac

SEQ ID NO: 9 - DNA, 30 bp, Artificial Sequence; identical to SEQ ID NO: 1
  Description of Artificial Sequence Synthetic primer

SEQ ID NO: 10 - DNA, 25 bp, Artificial Sequence
  Description of Artificial Sequence Synthetic primer
cgccaaagaatgatctgcggagctt

SEQ ID NO: 11 - DNA, 30 bp, Artificial Sequence
  Description of Artificial Sequence Synthetic primer
gcagcggataacaatttcacacaggagcgg

SEQ ID NO: 12 - DNA, 30 bp, Artificial Sequence; identical to SEQ ID NO: 1
  Description of Artificial Sequence Synthetic primer

SEQ ID NO: 13 - DNA, 25 bp, Artificial Sequence
  Description of Artificial Sequence Synthetic primer
cgccaaagaatgatctgcggagctt